(19) United States
(12) Patent Application Publication
(10) Pub. No.: US 2003/0054563 A1
(43) Pub. Date: Mar. 20, 2003

(54) Detector arrangement for microfluidic devices

(75) Inventors: Margnus Ljungstrom, Uppsala (SE); Jan Sjoberg, Uppsala (SE); Tobias Soderman, Uppsala (SE)

Correspondence Address: FULBRIGHT & JAWORSKI, LLP, 1301 MCKINNEY, SUITE 5100, HOUSTON, TX, 77010-3095, US

(73) Assignee: Gyros AB

(21) Appl. No.: 10/062,258

(22) Filed: Jan. 31, 2002

Related U.S. Application Data
(60) Provisional application No. 60/322,622, filed on Sep. 17, 2001.

(30) Foreign Application Priority Data
Sep. 17, 2001 (SE) 0103118-6
Dec. 31, 2001 (SE) 0104461-9

(51) Int. Cl. G01N 21/76; G01N 35/08

(52) U.S. Cl. 436/172; 436/164; 436/52; 422/81; 422/82.05; 422/82.08; 356/300; 356/317

(57) ABSTRACT

The present invention concerns a detector arrangement that is adapted to measure radiation from detector areas in the surface of a microfluidic device. The arrangement comprises a detector unit with a detector head and other units enabling for the detector unit to collect radiation from the detection areas.

### BACKGROUND OF THE INVENTION

This Application claims priority to U.S. Provisional Application No. 60/322,622, which was filed on Sep. 17, 2001, Swedish Application No. 0103118-6, which was filed on Sep. 17, 2001, and Swedish Application No. 010446-9, which was filed Dec. 31, 2001.

### FIELD OF THE INVENTION

The present invention generally concerns the field of microfluidic devices. More particularly, the present invention concerns a detector arrangement that is adapted to measure radiation from detector areas in the surface of a microfluidic device. The arrangement comprises a detector unit with a detector head and other units enabling for the detector unit to collect radiation from the detection areas.

### RELATED ART

A. Background Publications

Detector arrangements for measuring radiation signals from individual detection areas on a circular substrate have been described in a number of previous publications. See for instance:

EP 392475 (Idemitsu Petrochemical Co, Yamaji Kazutaka et al.) describes an analysis apparatus comprising a rotatable disc combined with a movable detector head that can transverse the disc in radial direction. The surface of the disc is divided into sectors. In one embodiment, there is a sensitized peripheral region/band in each sector. The bands are sensitized with antibodies specific to certain antigens that occur in serum. In use the original antigens labeled with a fluorescent group together with a serum sample is applied to the disc at an inner position relative to the band. By spinning the disc the sample plus the labeled antigens will pass the immobilized antibodies where they are complexed with the antibodies and detected.

U.S. Pat. No. 5,994,150 (Imation Corp, Challener et al.) suggests in general terms an analysis apparatus which combines a disc having a plurality of regions sensitized to one or more substances (sensor disc) with a detector and a motor for rotating the disc such that each sensitized region moves proximate to the detector. The apparatus utilizes optical diffraction phenomena in surfaces including surface plasmon resonance. Antibodies and antigens and indicator dyes may be used to sensitize the disc. Sensitizing substances are illustrated with enzymes, antibodies and antigens. There are no microchannels for transporting liquid aliquots.

U.S. Pat. No. 5,892,577 (The University Court of the University of Glasgow, Gordon) describes a system for the optical inspection of a biological sample on a rotating disc in which radiation leaving the disc contains one component indicating the presence of a substance in the sample and another component containing information about the position of the substance. The use of a home mark on the disc is indicated.

WO 9721090 (Gamera, Mian et al.) suggests that various kinds of detector arrangements can be applied to microfluidic devices in which liquid flow is created by spinning a microfluidic disc.

Duffy et al., “Microfabricated Centrifugal Microfluidic systems: Characterization and multiple Enzymatic Assays” (Anal. Chem. 71 (1999) 4669-4678) describe a colourometric enzyme assay in the microfluidic device of WO 9721090. Absorbance measurement is done while spinning the device. Fluorescence principles are indicated.

WO 0040857 (Amersham Pharmacia Biotech AB, Björkesten et al) suggests in one embodiment a linear detector head that scans a circular area by moving the head around the center of the area. The linear detector head comprises one or more rows of detector elements and is used to detect spots containing a labelled substance. The scanned area is primarily a 2-D electrophoresis gel. Microfluidic devices are not mentioned.

B. Background Technology and Problems

The present invention belongs to the field of miniaturization of processes which comprise sample treatment, assay protocols, chemical and/or biochemical synthesis etc., within medicine, chemistry, biochemistry, molecular biology and the like. At present one important goal within this field is to reduce the costs for these processes, for instance to reduce the amount of reagents needed per assay, reduce time per assay, etc. One route has been to increase the degree of parallelity, for instance by integrating as many as possible of similar process runs in one and the same device in order to carry out all the runs in parallel. At present, large numbers of research groups and companies are involved in developing technology that will solve the numerous problems encountered.

One problem is related to the optimal way of configuring the detector in relation to the microdevice used for performing the processes while maintaining an acceptable sensitivity and reproducibility. This problem may become particularly pronounced if the measuring step is performed by continuously moving the detector unit and the detection areas of a microfluidic device relative to each other during the measurement operation.

Another problem arises if the microfluidic device is in the form of a disc which is skewed because then it becomes difficult to maintain the optical focus in the right position relative to the detection areas. Without proper arrangement skewed discs will reduce sensitivity. This problem in particular applies to discs made of plastic material.

Another problem is related to maintaining an acceptable sensitivity and reproducibility when changing sample volumes from the μl-range to the nl-range and performing the process protocols with a high degree of parallelity within the same device. The inventors have found that under these circumstances the materials from which the microfluidic devices are fabricated and the various treatments during the manufacturing and conditioning of the devices easily introduce signal artifacts that are of the same kind and of comparable or larger size as the desired signals.

During recent years it has become popular to fabricate microfluidic devices in plastic material. This kind of material is typically highly fluorescent (“auto-fluorescent”) with emission wavelengths covering most of the wavelengths normally utilized in fluorescent measurements. Compared to microtitre wells and other uncovered microstructures the problem becomes more severe for the kind of covered microchannel structures used in the present invention, because the exciting and emitted radiation has to pass through plastic material. For transparent plastic material there is also a problem with “cross-talks” between the detection area/detection microcavities. Similar problems may also be at hand for spectroscopic methods in which the radiation to be measured is created within the detection microcavity (for instance chemiluminescence, bioluminescence, etc.).

A more recent problem relates to the fact that the present assignee recently has managed to control the liquid flow in microfluidic devices containing a plurality of microchannel structures in such a way that the inter-channel variation for a device with respect to flow becomes insignificant. This progress has enabled the assignee to quantify with a low inter-assay variation and a high sensitivity analytes, such as antigens, in the subfemtomole range in nl-volumes by carrying out the solid phase reaction of a heterogeneous sandwich immuno-assay under flow conditions in small columns (nl-columns). This has raised the question about measuring the amount of an affinity complex such as an immune complex as a function of position along the flow direction in a column. See U.S. application No. 60/322,621 and SE application (SE 0103117-8) filed on Sep. 17, 2001, which are incorporated by reference. See also assignee's poster presented on Sep. 17, 2001 at Proteomic Forum Sep. 16-19, 2001, Munich, Germany.

### BRIEF SUMMARY OF THE INVENTION

The present invention is directed to a system and method which meets the discussed problems.

A first subobject is to provide an improved detector arrangement and/or an improved method that enable parallel measurements of several detection areas in the surface of a microfluidic device of the kind described herein.

A second subobject is to provide a detector arrangement and a method that gives a high accuracy and reproducibility with respect to collecting radiation from the individual detection areas of a microfluidic device of the kind described herein. A similar subobject applies to irradiation if the detection principle used requires irradiation before collection of radiation.

A third subobject is to provide a detector arrangement and a method that enable an improved sensitivity for measuring a substance which is present in a detection microcavity of a microfluidic device via a detection area associated with the detection microcavity. This object means determination of amounts that are ≦10⁻¹³ mole, such as ≦10⁻¹⁵ mole or ≦10⁻¹⁸ mole, for instance in nl-volumes within the microfluidic device. These limits also refer to amounts of an analyte in a liquid sample which is introduced into and processed within a microchannel structure so that the radiation collected is a function of the presence/absence and amount of the analyte in the sample.

A fourth subobject is to provide a method for collecting and treating radiation data from detection area from microfluidic devices of the kind described herein.

A fifth subobject is to provide software and methods enabling accurate integration of radiation deriving from a desired substance as a function of subareas of individual detection areas. In particular this subobject aims at avoiding the problems discussed herein which the inventors have found may appear when measuring low amounts of substances with a high accuracy in microfluidic devices.

These objects in particular apply to measurements in discs that are spinning.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 illustrates a schematic view on an arrangement of the invention and its main parts.

FIG. 2 illustrates a detector head placed above a disc (microfluidic device) (cross-sectional view).

FIG. 3 illustrates a set of microchannel structures that can be used in a circular disc.

### DETAILED DESCRIPTION OF THE INVENTION

It is readily apparent to one skilled in the art that various embodiments and modifications can be made to the invention disclosed in this Application without departing from the scope and spirit of the invention.

As used herein, the use of the word “a” or “an” when used in conjunction with the term “comprising” in the sentences and/or the specification may mean “one,” but it is also consistent with the meaning of “one or more,” “at least one,” and “one or more than one.”

As used herein, the term “rotating” refers to spinning. Yet further, the term “rotating” may also include, but is not limited to a step-wise rotation of a disc.

As used herein, the term “reagent” includes, but is not limited to an analyte.

As used herein, the term “in a circular manner” refers to around the center of the disc (circumferential direction).

As used herein, the term “annular zone” refers to one or more detection areas. Thus, it is contemplated that there may be one, two, three or more such annular zones on the microfluidic disc device described herein.

The term “a plurality of microchannel structures” means two, three or more microchannel structures. Typically the term “plurality” means ≧10, such ≧50 or ≧100 microchannel structures.

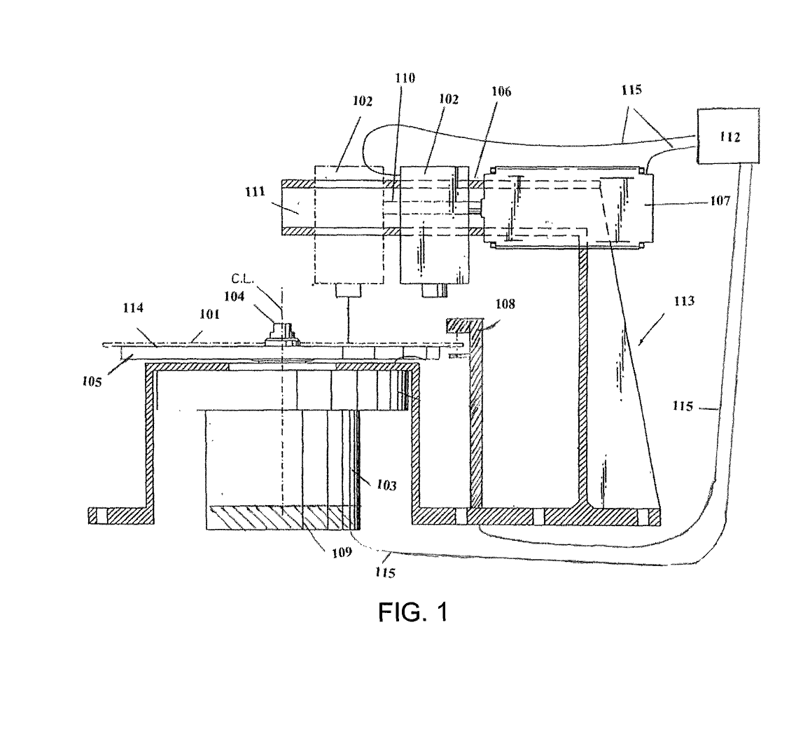

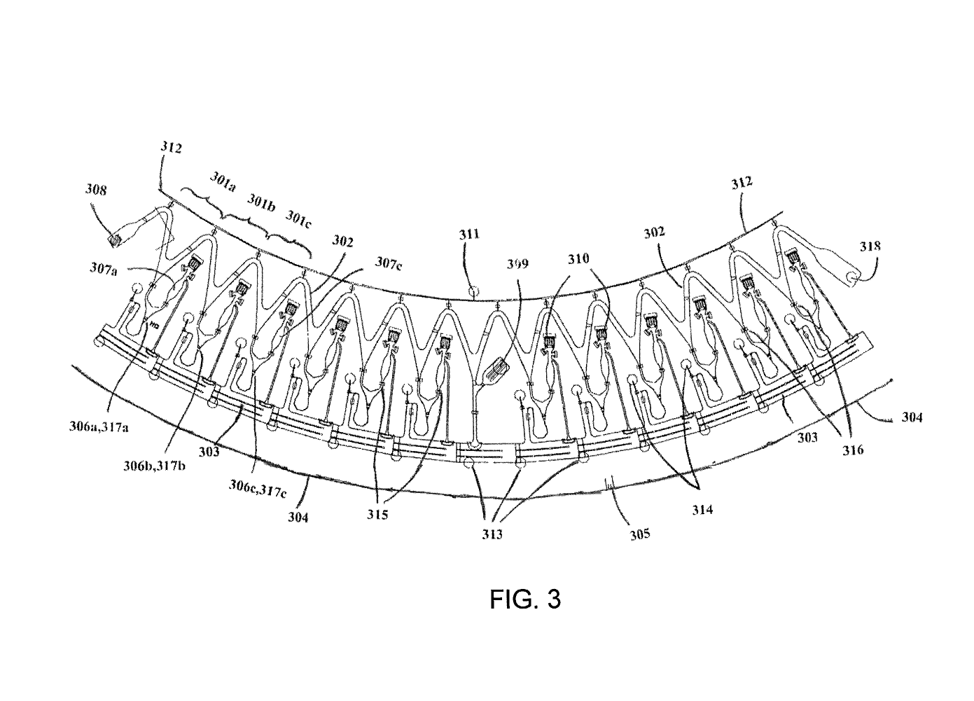

The first aspect of the invention is a detector arrangement that is adapted for measuring radiation from a plurality of detection areas (317a,b,c, etc., in FIG. 3) each of which is associated with a detection microcavity (306a,b,c, etc., in FIG. 3) in a microfluidic disc (101 in FIG. 1, 301 in FIG. 3). With reference to FIG. 1, the arrangement comprises:

(a) a detector head (102) with a focal area, and a disc holder (105) which are linked to a means enabling for the detector head (102), i.e., the focal area to transverse, the surface of the disc (101) in an essentially circular (means I) and/or radial manner (means II) when the disc is placed in the disc holder (105)

(b) an angular aligning system (108,109) for recognizing the angular position of the part area which at a particular time is covered by the focal area, and

(c) an optional radial aligning system (110,111) for recognizing the radial position of the part area which at a particular time is covered by the focal area, and

(d) a controller (112), e.g., computer with software, which controls

(i) means I and means II causing the focal area to transverse the detection areas (317a′,b′,c′, etc.) in an annular zone of the disc, and

(ii) the detector head (102) successively collects radiation in a preselected manner from individual subareas of essentially the same size as the focal area within at least one of the detection areas in said annular zone.

In specific aspects, it is contemplated that the disc holder (105) is linked to at least one of the means for enabling the detector head and the disc to move relative to each other so that the focal area transverses the surface of the disc. Thus, the disc holder (105) is linked to either means I or means II or both means I and means II.

Yet further, it is also understood by those of skill in the art that means I, means II, and the detector head can be linked directly or indirectly to the controller.

Means I comprises three main variants with respect to how the disc and detector moves:

(1) The disc is rotating around its axis of symmetry. In this variant, means I preferably comprises a spinner motor (103) and a shaft (104) carrying the disk holder (105). See FIG. 1.

(2) The detector head (focal area) is circularly moving around the axis of symmetry of the disc. In this variant, means I preferably comprises a spinner motor and a shaft with an arm that carries the detector head. This shaft typically has the same direction as the axis of symmetry of the disc when placed on the disc holder.

(3) A combination of (1) and (2).

Means II comprises three main variants with respect to how the disc and detector head moves:

(1) The disc is laterally moving in front of the detector head. In this variant, means II preferably comprises a motor for laterally moving the disc holder.

(2) The detector head (focal area) is laterally moving over the disc surface. In this variant, means II preferably comprises a linear frame (106) that carries the detector head, and a drive unit (107) for radial movement of the focal area, over a disc which is placed in the disc holder (105). See FIG. 1.

(3) A combination of (1) and (2).

The innovative arrangement is illustrated in FIG. 1.

I. Means I and the Angular Aligning System for the Detector Head

In a typical variant, the detector head (102) and the motor (103) (e.g., a spinner) with a rotatable shaft (104) carrying a disc holder (105) are supported on a frame structure (113). The motor (103) controls the rotating speed that can be varied, e.g., within an interval between 0-15,000 rpm, such as within an interval between 60-5,000 rpm. The rotation of the disc may be stepwise. When the disc is rotating, the focal area of the detector head will successively scan angularly adjacent part areas of the disc surface. Means I in FIG. 1 is according to variant (1) above and comprises the motor (103) and the shaft (104).

The disc holder (105) is preferably a plate on which the disc can be placed. The disc holder could also be a device that holds the disc at its periphery. In order to reduce wobbling of the disc (if the disc is skewed), the side (114) of the plate facing the disc may comprise a system of evenly distributed uncovered shallow grooves or channel openings that are connected to a vacuum system by which the disc can be sucked to the plate. See for instance SE application 0103109-5 filed on Sep. 17, 2001, which is incorporated herein by reference.

Detection areas may be present in one or both sides of the disc. If the disc holder is in the form of a plate as illustrated in FIG. 1 and the microfluidic disc has detection areas on the side opposing, it is important to secure the plate so as not to disturb the collection of radiation. The plate may thus have a smaller diameter than the disc with the detector areas being located in an annular zone that is not covered by the plate. Alternatively, the plate may be in a material that is translucent for the radiation utilized for the measurement, at least at the detector areas.

The angular aligning system may comprise:

(1) a device that will enable the determination of when a predetermined angular position of a disc placed on the disc holder is in front of the objective of the detector head (102) (i.e., covered by the focal area), and/or

(2) a home position mark detector (108) which is able to detect when a home position mark (305) on a rotating disc (101) placed on the disc holder (105) is passing.

A home position mark (305 in FIG. 3) is preferably placed in an outer circumferential zone outside the detection areas or in some other position, which can be detected with high accuracy. The position coordinates of each specific spot of the surface of the disc is given as the angular position relative to the home position mark and as the radial position relative to the circumference or axis of symmetry or relative to any other arbitrary fixed position on the disc.

A home position mark detector (108) typically has a fixed position outside the disc, for instance on the frame structure (113).

An accurate and preferred alternative for determining when a predetermined angular position is in front of the objective is to include an encoder that progressively gives the angular distance from the home position mark while the disc is rotating. This kind of encoder (109) is typically associated with means I, for instance the motor (103), the shaft (104) or the disc holder (105). By associating the encoder directly with the disc (101) it is likely that the most accurate determination will be accomplished. The encoder typically divides each revolution of the shaft into a large number of grades, for instance >5 000, such as >10 000 or >20 000 or >30 000. A simple but less accurate alternative is to include calculating means that calculates the time needed from a preset rotation speed and the angular distance between the predetermined position and the home position mark (i.e., from the preset rotation speed and the angular position co-ordinate). This kind of calculating means may be associated with the controller.

The angular aligning system should be able to give the angular position coordinate for the part of the disc which is in front of the objective with an accuracy of ±1°, such as within ±0.1° or within ±0.01° (provided there are 360° per revolution). The exact accuracy needed will depend on the size of the disc, radial position of the detection area, the required sensitivity, size of detection area, etc.

II. Means II and the Radial Aligning System for the Detector Head

The detector head (102) is guided on a linear frame (106) that may be the upper part of the frame structure (113) for linear displacement and positioning in a first plane P1, transversely through the central axis CL of shaft (104) and running in a radial direction thereto. The linear frame (106) prohibits uncontrolled movement of the detector head in any other direction relative to this linear displacement. The drive unit (107) for this displacement may be in the form of a translational responder for incrementally changing the position of the detector head (102) in the first plane P1 (radial movement) and for enabling scanning of radially adjacent subareas of a microfluidic disc device placed in the disc holder (105). Means II comprises the linear frame (106) and the drive unit (107) and is in FIG. 1 according to variant (2).

The drive unit (107) is associated with a unit (110) for determining the linear displacement and thus also the radial position coordinate of the part of the disc which is in front of the objective of the detector head (102). This unit (110) may be in the form of an encoder that gives a translational position and movement of the focal area (objective of the detector head) in relation to a translational home position (111) on the responder. This home position in turn may be associated with a unique radial position in the disc. The measuring unit (110) should be able to translate a translational position and movement of the detector head (focal area) into a radial position coordinate of the disc used with a high accuracy, typically within ±10 μm such as ±1 μm or ±0.1 μm.

The drive unit (107) and the vertical height of plane P1 may be adjustable for focusing purposes.

III. Controller

Control means, for instance electronic and programmable control means (schematically illustrated by reference numeral (112)) with operator's interface and software, not further disclosed, may be assigned to the detector arrangement among others for

a) recognizing one or more pairs of start/stop-positions (angular and/or radial) for irradiating if the detection principle utilized requires irradiation and/or for collecting radiation,

b) identifying individual subareas in detection areas or elsewhere in the surface of the disc,

c) controlling the simultaneous rotating of the disc and the incremental radial displacement of the detector head (102),

d) collecting radiation data from the detection areas/detection microcavities,

e) treatment and presentation of the collected data, and/or

f) determining the time at which a particular angular position is in front of the objective of the detector head from the rotational speed.

Different parts of the arrangement may communicate (115) with the controller (112). The controller will in the preferred variants instruct the detector head to successively collect radiation from distinct and preselected parts of the surface of the disc. Typically the controller is programmed to start collecting radiation at a position, primarily an angular and/or a radial position, which is prior to an intended detection area, and to end the collecting at a position, which is after the same detection area. Preferably the starting position and the ending position are at essentially the same radial distance. This means that the subareas from which radiation is collected primarily are located within detection areas. Yet further, in preferred variants, subareas close to the detection areas are also included. If the radiation requires that the substance is irradiated, which is the case if fluorescence is measured, the control means also defines the settings for the start and stop positions for irradiation. These latter settings are typically essentially the same as for collecting radiation.

The start and stop signals for collecting radiation is preferably directly linked to the angular positions in the disc at which collection is to start and end, respectively. This also includes that due account is taken for delays that may be inherent in the system or preset, i.e., the start and stop signals may have to be initiated before the focal area is positioned in front of the start and stop position, respectively. If the angular aligning system comprises an encoder, the encoder signals corresponding to a start position and a stop position are used to define the time period during which radiation is to be collected. In an alternative, the start and stop for collecting radiation is linked to a preset rotating speed, i.e., the controller calculates from a preset rotating speed the time at which the start and stop position should be in front of the objective.

The controller may be programmed to change the radial position of the detector head (focal area) after a predetermined number of revolutions of the disc, for instance after 1, 2 or more revolutions with preference for 1.

The controller may be capable of changing the radial position of the objective (focal area) during a revolution of the disc. For these variants, one can envisage that radiation is collected for all relevant subareas at a common angular position before the disc is rotated (in a single step) to a subsequent angular position. In an alternative variant the objective (focal area) is transversing the disc surface in a spiral-like manner, i.e., the radial position is changed successively during a revolution.

In the preferred variants, the collected radiation data is stored in a form that is retrievable for each individual subarea, for instance in the control unit. This means that after collecting of radiation, it will be possible to represent the collected data as a 3-D image of the detection area showing the amount of radiation from each individual subarea. In the case of overlapping subareas, the proper treatment of the data takes into account the overlapping effect and creates a true image of the radiation associated with different parts (subareas) of a detection area.

Radiation may be collected from a part of a detection area or from the total detection area dependent on the settings of the controller. Typically, radiation is collected from at least 50% of each detection area, such as at least 80% or at least 90% up to 100%. The subareas from which radiation are collected preferably are homogeneously distributed over a detection area and/or with or without overlap between subareas that are next to each other. The overlap, i.e., the part of a subarea which is common for two overlapping subareas, may be <25%, such as ≦15% or ≦5%. The overlap may also be ≧25 %. If so desired the settings may be selected to exclude collection from a detection area zone in which there is insignificant radiation, i.e., the corresponding zone in the detection microcavity associated with the detection area contains insignificant amounts of the substance influencing the radiation to be collected.

In certain aspects of the present invention, the individual subareas typically include, but are not limited to having the same dimensions as the focal area.

IV. Detection Principles and the Detector Head

The microfluidic devices used in the present invention typically require detection of very low absolute amounts or concentrations of substances in the detection microcavity. It is therefore imperative in many variants of the invention that the detection principle shall enable detection and quantification of substance amounts that are ≦10⁻¹² mole per detection area/detection microcavity, such as ≦10⁻¹⁵ mole or ≦10⁻¹⁸ mole per detection area/detection microcavity.

Typical detection principles may include, for example, spectrometric detection. Yet further, it is also contemplated that detection may be based on collecting radiation that is associated with the presence/absence and amount of a desired substance in a microcavity associated with a detection area. The detection principle is applicable to microfluidic devices in which the detection microcavities are also fabricated in black plastic material. Based on these criteria, detection principles based on absorbance of visible light passing through a detection microcavity are often ruled out. Typically the radiation is fluorescence, chemiluminescence, bioluminescence, scattered light etc.

For certain detection principles collecting of radiation requires irradiation. Applicable detection principles include, but are not limited to measuring a change in wavelength(s), polarization, life-time, scattering, intensity, etc., between irradiation and radiation as a function of the presence of the substance of interest in the detection microcavity. With respect to principles utilizing the measurement of radiation in form of light emitted from a desired substance, confocal technique can also be considered outstanding, in particular for discs made of plastic material. Typical examples include, but are not limited to luminescence and fluorescence principles, with laser induced fluorescence (LIF) being preferred.

The detector head typically is part of a detector unit and is capable of collecting radiation from the target area to a photon measuring unit. The target area may for instance be a part of a detection area. A typical detector head comprises an objective, and, if needed, a band pass filter which is selective for the radiation to be collected, and a lens system or the like for focusing the radiation from the focal area to the entrance of the photon measuring unit. The photon measuring unit may for instance be a photo multiplicator tube (PMT), an avalanche diode or the like. A light guide may be included for guiding the light to the photo multiplicator tube, avalanche diode, etc. In the case confocal technique is built into the system, a pin-hole or the like is placed in front of the entrance of the photon measuring unit. The pinhole is adapted (size and position) to preferentially permit photons from the focal area of the objective to pass into the photon measuring unit.

The detector head may also comprise a system for irradiating the target area if the detection principle utilized requires this. In this case, the system comprises a source for irradiation and the appropriate focusing system with an objective which focuses the irradiatiation to a focal area that coincides with the focal area from which radiation is collected. The irradiation source typically is a light source, which depending on the detection principle gives monochromatic light, for example, laser light, light of a predetermined band width, polarized light, etc. If confocal technique is built into the system, a pin-hole or the like may be placed between the irradiation source and the system.

The size of the focal area typically is less than the size of a detection area. The width of a focal area in one direction (direction 1) is typically essentially ≦⅕, such as of the ≦1/10, of the corresponding width of a detection area and in a perpendicular direction (direction 2) within the same limits or larger. In other variants, the focal area may have a size enable it to embrace one or more detection areas, for instance by covering detection areas or parts thereof that are at the same angular position co-ordinate(s). In preferred cases, the focal area is rounded, with specific emphasis for essentially circular variants.

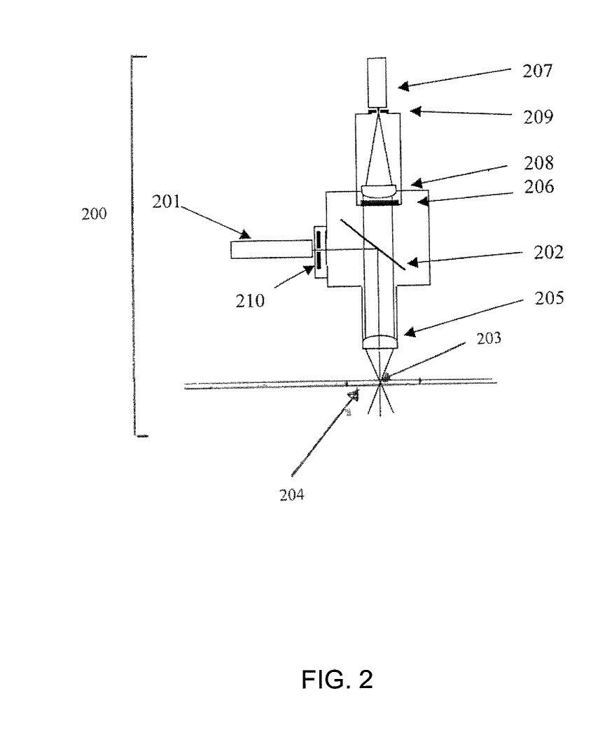

In preferred variants, the beam paths for irradiation and radiation, respectively, are coinciding but with opposite direction, at least in the part of the detector head which is closest to the objective, i.e., as illustrated in FIG. 2. The directions of the beam paths are preferably perpendicular to the target area (in this case the surface of a disc which is placed in the disc holder (105)).

In some preferred variants, the detector head may be a pick-up head which may be designed as illustrated in FIG. 2. This variant is in particular suitable for laser induced fluorescence (LIF) and is adapted for quantitative measurement of fluorescence from detection microcavities containing nl-volumes which are present in discs that can be spun. Confocal technique is also included.

The pick-up head (200) illustrated in FIG. 2 comprises a laser source (201) whose beam is reflected on a dichroic mirror (202) and focused through an objective (205) to a part of a detection microcavity (203) positioned in front of the head. The epi-fluorescent light is passed through the dichroic mirror and through a band-pass filter (206), selective for the flourochrome at hand and is finally focused onto the entrance of a photo multiplicator tube (PMT) (207) by means of an aspheric lens (208). Pin-holes (209 and 210) are positioned between the entrance of the laser beam and the dichroic mirror, and in front of the PMT (207). The size and position of the pin-hole (210) are adapted so that the focal area of the laser beam is inside the detection microcavity. The size of pin-hole (209) is adapted so that preferentially emission light emanating from the focal area is passed into the PMT (207). A mirror spot on a glass disc or the like may replace the dichroic mirror.

In the case fluorescence is to be measured, an alternative detector head is to use an acuosto optic tunable filter (AOTF) as suggested in WO 0039545 (Amersham Pharmacia Biotech AB, Tormod, hereby incorporated by reference).

The detector head may alternatively be in the form of a linear and/or an area detector head comprising one or more parallel rows of detector elements and being capable of collecting light from an area, e.g., in the form of a straight line oriented radially in relation to a disc which is placed on the disc holder (105). The detector elements may be so called avalanche diodes.

If fluorescence is utilized, the wavelength of the radiation coming from the light source is adapted to fit the excitation wavelength of the fluorochrome of the substance from which fluorescence is to be measured. In the case fluorochromes having separate emission wavelengths are to be measured from the same surface, it may be appropriate to include means that are capable of separating out the various emission wavelengths before measuring the photons. This may be accomplished by placing a filter, a gitter, a prism, etc., in the beam path before the photons are counted. See, for instance, DE 4419940, Tüngler; WO 9939165, Leica Microsystems, Engelhardt et al; and WO 9939231, Leica Microsystems, Enhelhardt which are hereby incorporated by reference.

If fluorochromes that differ in excitation wavelength are to be measured from the same disc surface, the detector unit may comprise a light source, which can be switched between the excitation wavelengths or which permits excitation of the different fluorochromes at the same time.

An alternative for measuring fluorochromes of different excitation and/or emission wavelengths by a common detector head is to incorporate separate detector heads for each fluorochrome in the detector unit.

By using a detection unit which is capable of measuring radiation from different fluorochromes, it will be possible to measure several substances in parallel, for instance their presence in the same microcavity.

What has been said above with respect to measuring fluorochromes of different emission wavelength also applies to luminochromes except that no irradiation is needed.

V. Microfluidic Device

The microfluidic device used in the various aspects of the invention comprises a plurality of microchannel structures in which aliquots of liquids are transported and/or processed. The devices typically are disc-shaped with the microchannel structures oriented in one or more planes. The structures are covered in the sense that their interior is in contact with ambient atmosphere primarily via separate inlet and/or outlet openings and/or vents. Each microchannel structure comprises one or more detection microcavities and possibly also one or more reaction microcavities, and microconduits connecting these parts with each other. A reaction microcavity may coincide with a detection microcavity. The result of the processing in a microchannel structure is measured as radiation from a detection area which is directly or indirectly associated with a detection microcavity. This includes that radiation can be guided within the microfluidic device from a detection microcavity to a part/surface area not directly associated with the microcavity, for instance via an optical fiber.

A disc typically has an axis of symmetry (Cn) where n is an integer >5 preferably ∞(C∞). In other words the disc is preferably circular. Once a disc of this kind has been selected it opens up the possibility to use spinning (centrifugal force) for driving liquid within the microchannel structure.

Different principles may be utilized for transporting the liquid aliquots within the microfluidic device/microchannel structures. Thus inertia force may be used, for instance by spinning the disc. Other forces are capillary forces, electrokinetic forces, hydrodynamic forces etc.

Microfluidic devices that have an axis of symmetry and are intended for rotation may have a home position mark as discussed above.

The microfluidic device may also comprise common channels connecting different microchannel structures, for instance common distribution channels for introduction of liquids and common waste channels including waste reservoirs. Common channels including their various parts such as inlet ports, outlet ports, vents, etc., are considered part of each of the microchannel structures they are connecting. Common microchannels may also connect fluidly groups of microchannel structures that are in different planes.

The terms “microchannel”, “microconduit”, etc., contemplate that a channel structure comprises one or more cavities and/or channels/conduits that have a cross-sectional dimension that is ≦103 μm, preferably ≦102 μm. The lower limit is typically significantly larger than the size of the largest reagents and constituents of aliquots that are to pass through a microchannel. The volumes of microcavities/microchambers are typically ≦1000 nl, such as ≦500 nl or ≦100 nl or ≦50 nl or ≦25 nl, which in particular applies to the detection microcavities. Chambers/cavities directly connected to inlet ports for liquids may be considerably larger, e.g., microchambers/microcavities intended for application of sample and/or washing liquids. Microformat means that one, two, three or more liquid aliquots that are transported within the device have a volume in the μl-range, i.e., ≦1000 μl such as ≦100 μl or ≦50 μl including but not limited to the nl-range (nanoformat), such as ≦1000 nl or ≦500 nl or ≦100 nl or ≦50 nl.

The microfluidic device may be made from different materials, such as plastics, glass, silicone polymers, etc. The detector area should be transparent/translucent for the detection principle utilized by the detector. From the manufacturing point of view plastic material is many times preferred because the costs for the material are normally low and mass production can easily be done, for instance by replication. Typical manufacturing processes involving plastic material are replication by embossing, moulding, etc., followed by attaching a top lid covering the open microchannel structures so obtained. See for instance WO 9116966 (Pharmacia Biotech AB, Öhman & Ekström). However, plastic materials may interfere with several sensitive detection principles. Their high auto-fluorescence is disadvantageous for normal fluorescence techniques in case low absolute amounts of fluorescent substances are to be measured. This points to the fact that it is important to match the material in the device with the detection principle used. At the priority date of this invention the preferred disc material is plastic material, such as polycarbonates and plastic material based on monomers which consist of a polymerisable carbon-carbon double or triple bonds and saturated branched straight or cyclic alkyl and/or alkylene groups. Typical examples are Zeonex™ and Zeonor™ from Nippon Zeon, Japan, with preference for the latter. See for instance WO 0056808 (Gyros AB, Larsson, Ocklind and Derand) which is hereby incorporated by reference. In this context silicone polymers such as poly dimethyl siloxane (PDMS) and the like are not considered to be plastic material.

It is known that black plastic material, for instance containing graphite powder or carbon black, absorbs light and therefore has a low auto-fluorescence. Transport of light within black plastic material is prevented. Black plastic material will be very efficient for microfluidic devices when fluorescence and luminiscence measurements are relied upon. Black plastic material should in this case be avoided in the detection areas.

In case a lid is needed as for most discs obtained by replication, plastic lids of different origin may be used, for instance Melinex™ 12 PET and Melinex™ 17 OPP (Du Pont, U.S.A.), etc.

From the auto-fluorescent point of view an optimal combination of transparent plastic material appears to be Zeonor™ replication and Melinex™ 17 OPP as the lid. This combination of material is likely to be useful for excitation wavelengths in the interval 480-650 nm.

The plurality of detection microcavities and the corresponding detection areas are preferably arranged in subgroups such that all members of a subgroup are positioned at the same radial distance and/or at the same angular position and/or have equal length and/or cross-sectional dimensions. Within each subgroup there may be at least two, three or more detection microcavities (detection areas), such as ≧10 or ≧25 or ≧50 detection microcavities (detection areas).

A detection area in the inventive arrangement typically has a size within the range of 1×10²-2×10⁶ μm², such as 1×10³-10⁵ μm². Their length and/or breadth are typically within the range of 0.5×10-5×10⁴ μm, such as 1×10-10⁴ μm.

The experimental part of the copending patent applications U.S. No. 60/322,621 and SE 0103117-8 present results obtained with the present invention. The design of the microchannel structures (301a,b,c, etc.) used is illustrated in FIG. 3. The structures are linked together by a common distribution channel (302) and a common waste channel (303). The orientation of the microchannel structures around a common axis of symmetry is apparent. The circumference (304) of the disc has a home position mark (305). Each of the combined reaction/detection microcavities (306a,b,c, etc.) is communicating in the downstream direction with the common waste channel (303) and in the upstream direction via separate connections with the common distribution channel (302) and separate volume measuring units (307a,b,c, etc.). A surface detection area (317a,b,c, etc.) is associated with each detection microcavity. The common distribution channel (302) carries at one of its ends and at an intermediary position inlet ports (308 and 309, respectively). Another kind of inlet port (310) is located at each volume measuring unit (307a,b,c, etc.). Each microchannel structure (301a,b,c, etc.) also has an outlet to the common waste channel (303) and an outlet port (318) at the remaining end of the common distribution channel (302). An inlet vent (311) to ambient atmosphere is connected to the common distribution channel via a common venting channel (312). Other vents (313 and 314) to ambient atmosphere are placed in the common waste channel (303) and in the connecting microconduit between each reaction/detection microcavity (306a,b,c, etc.) and the common waste channel (303). Appropriate valvings are positioned at 315 and 316 in each microchannel structure (301a,b,c, etc.).

The diameter of the preferred discs is about the same as conventional CDs but may be larger or smaller, for instance up to 300% or larger and down to 10% or less.

VI. Processes to be Preformed within the Microfluidic Device

The processes that are carried out within the individual microchannel structures comprise assay protocols, organo-chemical or biochemical synthesis protocols, etc. Typically the protocols comprise introduction of one or more liquid aliquots containing the necessary reagents/reactants into a microchannel structure. In the case of assay protocols, one of the aliquots is a sample which is uncharacterized with respect to at least one feature, e.g., type, form and/or amount of an analyte.

The processes comprises that the substance, which is associated with the radiation to be collected, is formed and/or retained in the detection microcavity under static conditions or under flow conditions. The reaction system for retaining may be homogeneous or heterogeneous, i.e., with or without the desired substance being partitioned between a liquid phase and a solid phase. In case of flow conditions and microfluidic devices in the form of discs, the flow direction in the detection microcavity may be towards the circumference (outwards) or towards the center of the disc (inwards), or essentially parallel with the circumference of the disc. Also other directions may be utilized.

Process protocols may utilize specific reactions between reactants having mutual affinity to each other leading to a (a) formation of an affinity complex that is immobilized to a solid phase in a detection microcavity or (b) one or more other reaction products that may be soluble or insoluble in the detection microcavity. By properly selecting the reaction conditions including selection of reactants, it can often be arranged so that the product obtained and/or a reagent in excess are detectable with a signal that can be (a) measured from the above-mentioned detection areas and (b) related to one or more features of a starting liquid aliquot introduced into a microchannel structure. Typical such features are kind, form and amount including activity, etc., of a particular reactant including for instance an affinity reactant such as an enzyme etc. The term “can be related to one or more features” includes also the determination of the manner in which reaction variables such as pH, ionic strength, detergents, etc., might influence the reaction used for forming the reaction product. Typically, one makes use of detection principles based on radioactivity, fluorescence, chemiluminescence, bioluminescence, enzymatic activity, chromogens, light scattering (turbidometry), etc., for instance by utilizing a reactant that carries a group providing detectability, either by being detectable as such or by being transformable to a detectable group. Typically the utilized process protocol means that a detectable reactant is incorporated into a complex or into some other reaction product. See for instance, applications U.S. No. 60/322,621 and SE 0103117-8. Detectable products, reagents, etc., that can be retained and measured in a microcavity are collectively called “substance” in other parts of this specification.

Typical reactants in this context include members of affinity pairs such as (a) antigen/hapten and the corresponding antibody including its antibody active fragments, (b) lectin and the corresponding carbohydrate structure, (c) native ligands and the corresponding receptors, (d) complementary nucleic acids including synthetic variants such as synthetic oligonucleotides, (e) Ig(Fc)-binding proteins and Protein A, Protein G and other Ig(Fc)-receptors, (e) ion pairs of opposite charges, enzyme and the substrate, inhibitor, cofactor, coenzyme etc., that can bind to the enzyme, etc. Synthetic variants more or less mimicking a native affinity interaction are also included.

The second innovative aspect comprises an arrangement comprising:

(a) a microfluidic device in which there are one, two or more detection microcavities fabricated in plastic material. Each detection microcavity is associated with a detection area on the surface of the device, and

(b) a detector with a detector head for collecting radiation emitted from a substance via a detection area. The substance is present in the detection microcavity that is associated with the detection area.

The characteristic feature is that the detector head utilizes confocal technique.

Details about the various parts of the arrangement and confocal technique are given elsewhere in this specification. This aspect is primarily useful for detectors measuring radiation in the form of fluorescence and/or luminescence.

The third innovative aspect is a method for determining the amount of a substance in a detection microcavity of a microfluidic device and comprises collecting radiation associated with the substance from a detection area associated with the detection microcavity. The method is characterized in comprising the steps of:

a) providing

(i) a microfluidic device, e.g., in the form of a disc, comprising

A) a plurality of microchannel structures, each of which has an inlet port, a detection microcavity and a microconduit connecting the inlet port with the detection microcavity, and

B) a plurality of detection areas, each of which being (1) associated with one of said detection microcavities, (2) present in the surface of said device and (3) translucent/transparent for said radiation, and

ii) a detector arrangement which is capable of collecting radiation from individual subareas of each of said detection areas;

b) processing one or more liquid aliquots in at least one of said plurality of microchannel structures so that the substance is retained in the detection microcavity of each of said at least one of said plurality of microchannel structures, provided that said substance and/or one or more reagents that are necessary for the substance to be retained in a detection microcavity are present in at least one of said one or more aliquots;

c) scanning the detection areas associated with the detection microcavities that are part of microchannel structures in which step (b) has been carried out to obtain radiation from individual subareas of each scanned detection area, said scanning being performed by the use of said detector arrangement;

d) integrating radiation as a function of the subareas of each scanned detection area to obtain the amount of radiation from each detection area;

e) characterizing for each of the amounts obtained in step (d) a reaction variable that has been included in the process protocol used for each microchannel structure.

Further details about characterization of reaction variables are discussed above and in our copending patent applications U.S. S. No. 60/322,621 and SE 0103117-8. The characterization includes e.g., that the amount of substance in each of the detection microcavities is determined from each of the amounts obtained in step d).

The microfluidic disc and steps b) and c) are illustrated elsewhere in this specification. In addition to circular scanning, e.g., by rotating a disc, step (c) also comprises non-circular scanning for instance scanning by lateral movement of a linear detector head comprising one or more rows of detector elements over the detection areas. Also imaging by a CCD camera is included. The microfluidic disc may be circular or have some other geometric form, for instance triangular, rectangular, etc., including also irregular forms.

Step (d) means integration over each detection area, i.e., primarily over subareas which have radiation values that deviate from the values obtained for surface parts of the device that surrounds the detection area. Alternatively one may exclude all or selected parts of a detection area which corresponds to parts of a detector microcavity in which the presence of the substance is insignificant. The integrating step includes the substeps of (a) finding a start and/or stop position at edges of the detection area, e.g., at an end corresponding to the inlet end of the detection microcavity, and (b) the factual integrating. In one variant substep (a) is carried out by determining the inflection point for the amount of radiation per subarea versus position along the detection area. Due the fact that the delineating part of the detection area may be curved, at the upstream end, the invention also suggests that the integration should account for curvatures in the circumference of a detection area. In a preferred variant, substep (a) comprises determining a threshold that segments detection area pixels from the background, e.g., if the detection microcavity is filled with a particle bed a threshold that segments the particle bed pixels from background pixels. This can be done with optimal thresholding or determining median or mean background or any other way of determining background (for “optimal thresholding” see for instance “Digital Image Processing”, 2nd edition, Editors: Gonzales R C et al, page 354). In this case substep (b) will mean integrating a selection of pixels, i.e., those pixels which have radiation values above the threshold and belong to the main group (detection area) and excluding noise pixels above threshold that do not belong to the main group of connected pixels. The integrating typically starts from pixels corresponding to one end of the detection area, e.g., the inlet end.

Between the preferred variant of substeps (a) and (b), there are preferably additional substeps for refining the method, such as

i) Creating a binary image from the calculated threshold.

ii) Labelling the high binary pixels into different groups (=labeling the image). Each group will consist of pixels that are bordering to each other (close to each other). The binary high pixels from the detection area will define the main group.

iii) Optionally removing all binary high pixels that do not belong to the main group.

The factual integrating (main step d) will in this case mean integrating the radiation values for the binary high pixels of the main group.

The inventors have found that when working with very small volumes and amounts, the material from which a device is manufactured as well as the pretreatment procedures may introduce radiation artifacts in form of peak noise that is comparable to the radiation coming from subareas outside the peak. Therefore step (d) may also comprise substeps for removing peak noise. This typically means a first substep in which the deviating radiation (peaks) are made more apparent. One way of doing this is 1a Place filtering, point detection and the like. See for instance “Digital Image Processing”, 2nd edition, Editors: Gonzales R C et al, pages 333, 334 and 339 (1987). In a subsequent substep the width and the position of each peak is calculated for instance by including edge detection or edge linking based on a local area etc. See for instance “Digital Image Processing”, 2nd edition, Editors: Gonzales R C et al, pages 334 and 344 (1987). In the next substep the peak noise is removed by interpolating from surrounding subareas. An alternative way to the whole process of removing peaks is morphological opening, un-linear filtering operating in local histogram domains etc. These substeps for removing peak noise is performed prior to the factual integration.

Step (e) is conventional and typically includes that the integrated value is compared with the value for one or more standards. A standard value is typically the integrated value for a known amount of a standard substance, which in most cases is the same as the substance under investigation.

The scanning step (c) and integrating step (d) may in certain innovative variants of the third aspect of the invention be optional. Thus, these steps are preferably included when the desired substance is unevenly distributed within the detection microcavity. In a typically case, this may happen when the substance is retained within the detection microcavity under flow conditions, for instance by being captured to a solid phase introduced into the microcavity prior to the fluorescent substance.

In the that case the substance is homogenously distributed within the detection microcavity, the scanning step (c) and integrating step (d) may be replaced with collecting the radiation intensities for selected subareas of a detection area and letting these intensities represent the total amount of radiation from the detection area, for instance as a mean or maximum value. Step (e) can then be carried out on these values in the same manner as for values obtained by scanning and integrating. This way of performing the method is also a part of the present invention.

Homogenous distribution of the substance in the detection microcavity typically is at hand in case the substance is present in the detection microcavity in an equilibrated solution and/or when a reaction is going in the microcavity between homogeneously distributed reactants either forming or producing the substance that is to be detected.

The innovative method of the third aspect includes that steps (d) and/or (e) are performed in close connection to the preceding steps [(a)-(c) or (a)-(d), respectively] and/or that the data from the scanning and/or the integrating have been obtained at an earlier time, for instance at a different geographical location, and/or by different individuals.

Steps d) and e) are typically performed by the appropriate software for instance included in the controller or elsewhere, for instance not in physical association with the innovative arrangements described herein.

The invention also comprises computer program-related aspects for treating radiation data that have been assembled by steps (a)-(c) of the innovative method. One such aspect is a computer program product that

(1) comprises program code elements corresponding to a sequence variant of step (d) above comprising one or more of the substeps described for this step, and

(2) when installed on the appropriate hardware is capable of causing the hardware (computer) to execute the sequence of substeps on data which have been obtained by performing step (c) above on any kind of microfluidic device irrespective of being spinnable or not.

Other code elements may be included, for instance corresponding to step (e) in order to execute the sequence (d)-(e). Another computer program-related aspect is the computer program product stored at a computer program readable means which, when the product is loaded, makes it possible for a computer to perform the sequence of steps corresponding to the code elements in the stored computer program product. A third computer program-related aspect is a carrier having at least one of the innovative computer program products thereon. The carrier may be a computer memory, a Read-Only Memory or an electrical signal carrier.

Certain innovative aspects of the invention is defined in more detail in the appending claims. Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A detector arrangement that is adapted for measuring radiation from selected detection areas in a microfluidic device comprising: a disc with an axis of symmetry, and at least one detection area which is associated with a detection microcavity containing a substance causing radiation to be measured, wherein said arrangement comprises:
(a) a detector head with a focal area,
(b) a disc holder comprising a means I that enables the focal area to transverse the surface of the disc in an essentially circular manner or a means II that enables the focal area to transverse the surface of the disc in an essentially radial direction,
(c) an angular aligning system for recognizing the angular position of a part area which at a particular time is covered by the focal area, and
(d) a radial aligning system for recognizing the radial position of a part area which at a particular time is covered by the focal area, and
(e) a controller that controls means I and means II causing the focal area to transverse the detection areas in an annular zone of the disc, and the detector head collects radiation in a preselected manner from individual subareas within at least one of the detection areas in said annular zone.

2. The arrangement of claim 1, wherein said disc holder comprises means I and means II.

3. The arrangement of claim 1, wherein said detector head is used for laser induced fluorescence.

4. The arrangement of claim 3, wherein said laser induced fluorescence is combined with a confocal technique.

5. The arrangement of claim 1, wherein the focal area has dimensions such that it covers at least one selected detection area which is at the same angular position.

6. The arrangement of claim 1, wherein the focal area has dimensions such that it covers only a part of the detection area.

7. The arrangement of claim 1, wherein said disc comprises a home position mark.

8. The arrangement of claim 7, wherein said means I comprises a spinner.

9. The arrangement of claim 8, wherein said angular aligning system comprises an encoder in which the grades of the encoder are linked to angular positions on the disc relative to the home position mark.

10. The arrangement of claim 9, wherein said means II comprises a translation responder for moving the detector head in a radial direction.

11. The arrangement of claim 1, wherein said disc is made of plastic material.

12. The arrangement of claim 11, wherein said plastic material is black.

13. The arrangement of claim 1, wherein said substance is immobilized in the detection microcavity during flow conditions.

14. An arrangement comprising a microfluidic device and a detector head, wherein said microfluidic device is fabricated in plastic material and comprises at least one detection microcavity which is associated with a detection area on the surface of said device, and wherein said detector head utilizes confocal technique and comprises an objective for collecting radiation associated with a substance which is in said detection microcavity.

15. The arrangement of claim 13, wherein the radiation is fluorescence or luminescence.

16. The arrangement of claim 13, wherein the radiation is laser induced fluorescence.

17. The arrangement of claim 13, wherein said device is a circular disc which is spinnable so that the objective is capable of transversing the surface of the disc in a circular motion.

18. The arrangement of claim 16, wherein the detector head is radially movable so that the objective is capable of transversing the disc in a radial manner.

19. A method for determining the amount of at least one substance comprising the steps of:
(a) providing a microfluidic device and a detector arrangement, wherein said microfluidic device comprises a plurality of microchannel structures, each of which has an inlet port and a detection microcavity, and a plurality of detection areas, each of which is associated with one of said detection microcavities; and wherein said detector arrangement is capable of collecting radiation from individual subareas of each of said detection areas;
(b) processing one or more liquid aliquots in at least one of said plurality of microchannel structures so that said substance is retained in the detection microcavity of each of said at least one of said plurality of microchannel structures;
(c) scanning the detection areas associated with the detection microcavities that are part of microchannel structures in which step (b) has been carried out to obtain radiation from individual subareas (pixels) of each scanned detection area, said scanning being performed by the use of said detector arrangement;
(d) integrating radiation as a function of subarea for each scanned detection area to obtain the amount of radiation from each detection area; and
(e) characterizing for each of the amounts obtained in step (d) a reaction variable that has been included in the process protocol used for each microchannel structure.

20. The method of claim 18, wherein the influence of peak noise pixels on the result of the integrating is removed in step (d).
